(19) United States
(12) Patent Application Publication
(10) Pub. No.: US 2003/0202439 A1
(43) Pub. Date: Oct. 30, 2003

(54) Data recording controller

(76) Inventor: Takuya Shiraishi, Ogaki-shi (JP)

Correspondence Address: FISH & RICHARDSON PC, 225 FRANKLIN ST, BOSTON, MA, 02110, US

(21) Appl. No.: 10/422,151

(22) Filed: Apr. 24, 2003

(30) Foreign Application Priority Data
Apr. 25, 2002 (JP) 2002-124465

(51) Int. Cl. G11B 7/0045

(52) U.S. Cl. 369/47.3; 369/59.11

(57) ABSTRACT

A data recording controller includes a timing control circuit for activating a modulation circuit at a timing that is earlier than the timing at which a spot of a laser beam reaches a recording initiation position by the total of the time required for modulation, the time required for generation of the recording pulse signal, and a predetermined margin time. The timing control circuit waits until a timing in which the laser beam spot reaches the recording initiation position before outputting a recording pulse signal, which corresponds to the data that is to be recorded, from a write strategy circuit.

### CROSS-REFERENCES TO RELATED APPLICATIONS

This application is based upon and claims the benefit of priority from prior Japanese Patent Application No. 2002-124465 filed on Apr. 25, 2002, the entire contents of which are incorporated herein by reference.

### BACKGROUND OF THE INVENTION

The present invention relates to a data recording controller, and more particularly, to a data recording controller for starting the recording of data when a laser beam is radiated on a certain position of a disk medium.

Generally, when recording data on a recording medium, the data is converted (modulated) to channel data, which is in accordance with the characteristic or format of the recording medium, and then recorded. The modulated data, or the channel data, stabilizes the recording of data to the recording medium and the reproduction of data from the medium.

When the disk medium is, for example, a digital versatile disc (DVD), the channel data is normally generated by performing 8-16 modulation on data. In the 8-16 modulation, 8-bit data is converted to 16-bit data, and a synchronizing signal is added to the 16-bit data. FIG. 1 shows the channel data format of DVD. Each piece of channel data includes 32 bits of a synchronizing signal (sync section) and 1456 bits of modulated data. The 1456 bits of modulated data is generated by performing 8-16 modulation on 728 bits of data. The 32-bit synchronizing signal is added to a sync section, which is in front of each piece of modulated data to generate a frame of channel data. In a DVD, 26 frames of channel data form a single sector. Referring to FIG. 1, in the channel data format of a sector, 26 frames of channel data are arranged in 13 rows.

Each piece of channel data undergoes modulation to accurately perform data reproduction. For example, when performing non return to zero inverted (NRZ1) modulation, a pulse signal (NRZI data), which inverts the logic level, is generated whenever the bit content of the channel data becomes 1. The NRZI data is recorded on a recording medium.

When recording the NRZI data on a DVD, to form pits accurately on the DVD, the NRZI data undergoes pulse modulation and a recording pulse signal is generated to control the intensity and radiation time of the laser beam radiated on the DVD. The laser beam is radiated in accordance with the recording beam signal to form pits, which correspond to the channel data (NRZI data), on the DVD.

To properly record data on the DVD, the timing at which the position of the laser beam spot (radiation beam) reaches the desired position on the DVD must be synchronized with the output timing of the recording pulse. In the data recording controller, the following operation is performed to start data recording when the laser beam spot reaches the desired position on the DVD, which rotation is controlled.

The optical disc (DVD) 201 has a spiral pregroove and land prepits (LPPs) formed near the pregroove. The pregroove extends in a wobbled manner. The wobbling of the pregroove is used as a wobble signal having a predetermined cycle. The LPPs are formed at predetermined intervals along the pregroove. A set of LPPs is allocated to two frames of channel data. The LPP signal includes synchronizing information corresponding to the sync section, position information of the disk, and specification information.

To record data to the optical disk 201, data is read from a DRAM 210. The modulation circuit 220 modulates the data to generate modulated data, such as channel data or NRZI data. To form proper pits corresponding to the modulated data on the optical disk 201, the write strategy circuit 230 generates a recording pulse signal in accordance with the modulated data. In accordance with the recording pulse signal, an optical head 240 radiates a recording laser beam to the optical disk 201.

To record the modulated data at a predetermined position on the optical disk 201, the laser beam spot is positioned. More specifically, a reproduction laser beam is radiated to the optical disk 201, the rotation of which is controlled. The reflection of the laser beam is received by an optical head 240. The LPP signal extracted from the reflection is retrieved by an address generation circuit 260. The address generation circuit 260 decodes the LPP signal to generate a synchronization signal, which corresponds to the sync section, and an address signal, which corresponds to the position information of the optical disk 201. The synchronization signal and the address signal are provided to a timing control circuit 270. The processing performed by the timing control circuit 270 will now be discussed with reference to FIG. 3A.

Based on the received address signal, the timing control circuit 270 calculates the position of the laser beam spot on the optical disk 201. The timing control circuit 270 also calculates the timing at which the spot position reaches the desired position for starting recording (recording initiation position). Further, the timing control circuit 270 provides the modulation circuit 220 with a start trigger signal for starting modulation at a timing earlier than the calculated timing by the time the modulation circuit 220 and the write strategy circuit 230 requires for processing (a1).

In response to a start trigger signal, the modulation circuit 220 starts to perform modulation to generate modulated data and provides the modulated data to the write strategy circuit 230 (a2). The write strategy circuit 230 sequentially generates the recording pulse signal from the received modulated data and sequentially transfers the generated recording pulse signal to a gate circuit 250 (a3). The processing from the generation of the modulated data to the transfer of the recording pulse signal is performed successively. In accordance with the address signal, the timing control circuit 270 provides the gate circuit with a gate signal at the timing in which the laser beam spot reaches the recording initiation position on the optical disk 201 (a4). The gate circuit 250 opens in response to the gate circuit 250 and provides the recording pulse signal to the optical head 240 from the write strategy circuit 230 (a5). As a result, when the laser beam spot reaches the recording initiation position on the optical disk 201, the recording pulse is transmitted to the optical head 240 to start the recording of data from the recording initiation position on the optical disk 201.

While detecting the position of the laser beam spot on the disk from the address signal read from the optical disk 201, the data recording controller of the prior art performs conversion to modulated data, conversion of the modulated data to a recording pulse signal, and determination of the timing for outputting the recording pulse signal to the optical head 240. However, when the rotation speed of the optical disk 201 changes slightly or when a pickup of the optical head 240 sways sideward, the recording of data may not be started at the proper timing.

When the rotation speed changes or when the pickup sways sideward, the output timing of the recording pulse signal differs from the timing at which the laser beam spot reaches the recording initiation position. For example, as shown in the state of FIG. 3B, when the write strategy circuit 230 starts to output the recording pulse signal, if the laser beam spot has not reached the recording initiation position on the optical disk 201, that is, if there is a delay, (b3, b4, and b5), the head of the data subject to recording is not recorded. Thus, recording to the optical disk 201 starts from the middle of the data.

This problem not only occurs in the prior art data recording controller of FIG. 2 but also occurs in data recording controllers that perform predetermined data conversions.

### SUMMARY OF THE INVENTION

In one aspect of the present invention, a controller controls the recording of data using a recording laser beam to a disk medium from which an address signal is read. The controller includes a modulation circuit for modulating data that is to be recorded to generate modulated data. A write strategy circuit is connected to the modulation circuit to generate a recording pulse signal for controlling output of the recording laser beam in accordance with the modulated data. A timing control circuit is connected to the write strategy circuit to control operation timing of the modulation circuit and the write strategy circuit in accordance with the address signal read from the disk medium. The timing control circuit temporarily stops operation of the modulation circuit and the write strategy circuit and starts operation of the modulation circuit and the write strategy circuit when the position of a spot of the recording laser beam on the disk medium reaches a recording initiation position.

A further aspect of the present invention is a controller for controlling the recording of additional data using a recording laser beam to a disk medium from the end of data that has already been recorded on the disk medium. The controller includes a modulation circuit for modulating the additional data to generate modulated data. A write strategy circuit is connected to the modulation circuit to generate a recording pulse signal for controlling output of the recording laser beam in accordance with the modulated data. A gate circuit is connected to the write strategy circuit to send the recording pulse signal to the external circuit. A timing control circuit controls the operation timing of the modulation circuit, the write strategy circuit, and the gate circuit. The timing control circuit generates a recording pulse signal corresponding to the additional data by operating the modulation circuit and the write strategy circuit during a predetermined period while stopping the operation of the gate circuit, temporarily stops the modulation circuit and the write strategy circuit immediately before the write strategy circuit outputs the recording pulse signal corresponding to the additional data, and starts the operation of the modulation circuit, the write strategy circuit, and the gate circuit at a timing in which a spot of the recording laser beam on the disk medium reaches a recording initiation position.

A further aspect of the present invention is a controller for controlling the recording of data using a recording laser beam to a disk medium. The controller includes a modulation circuit for modulating data that is to be recorded to generate modulated data. A write strategy circuit is connected to the modulation circuit to generate a recording pulse signal for controlling output of the recording laser beam in accordance with the modulated data. A gate circuit is connected to the write strategy circuit to output a recording pulse signal. A timing control circuit controls the operation timing of the modulation circuit, the write strategy circuit, and the gate circuit. The timing control circuit calculates the timing at which the recording laser beam spot reaches a recording initiation position on the disk medium and activates the modulation circuit at a timing that is earlier than the calculated timing by the total of the time required for modulating a predetermined number of bits of the data that is to be recorded, the time required for generation of the recording pulse signal from the modulated data, and a predetermined margin time.

A further aspect of the present invention is a controller for controlling the recording of data using a recording laser beam to a disk medium. The controller includes a modulation circuit activated in response to a start trigger signal and inactivated in response to a stop signal. The modulation circuit modulates input data to generate modulated data. A write strategy circuit is activated in response to the start trigger signal and inactivated in response to the stop signal. The write strategy circuit generates a recording pulse signal for controlling output of a recording laser beam in accordance with the modulated data. A gate circuit is connected to the write strategy circuit to send the recording pulse signal to an external circuit in response to a gate signal. A timing control circuit generates the start trigger signal, the stop signal, and the gate signal. The timing control circuit calculates the timing at which the recording laser beam spot reaches a recording initiation position on the disk medium to provide the modulation circuit and the write strategy circuit with the start trigger signal at a timing that is earlier than the calculated timing by the total of the time required for generating the recording pulse signal from a predetermined number of bits of the data that is to be recorded and a predetermined margin time. The timing control circuit also provides the modulation circuit and the write strategy circuit with the stop signal immediately before the write strategy circuit outputs the recording pulse signal. Further, the timing control circuit provides the modulation circuit and the write strategy circuit with the start trigger signal and provides the gate circuit with the gate signal at a timing in which the recording laser beam spot reaches the recording initiation position.

A further aspect of the present invention is a method for controlling the recording of data using a recording laser beam to a disk medium. The method includes calculating a timing in which a spot of the recording laser beam reaches a recording initiation position on the disk medium, starting generation of modulated data at a timing earlier than the calculated timing by a total of the time required for generating a recording pulse signal, which controls the recording laser beam, from data that is to be recorded and a predetermined margin time, temporarily stopping the generation of the modulated data and the generation of the recording pulse signal when the recording pulse signal corresponding to the data immediately before the data that is to be recorded is output, and generating the modulated data and restarting the generation of the recording pulse signal at a timing at which the laser beam spot reaches the recording initiation position.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagram illustrating the format of the channel data in a single sector of the DVD;

FIG. 2 is a block diagram of a prior art data recording controller;

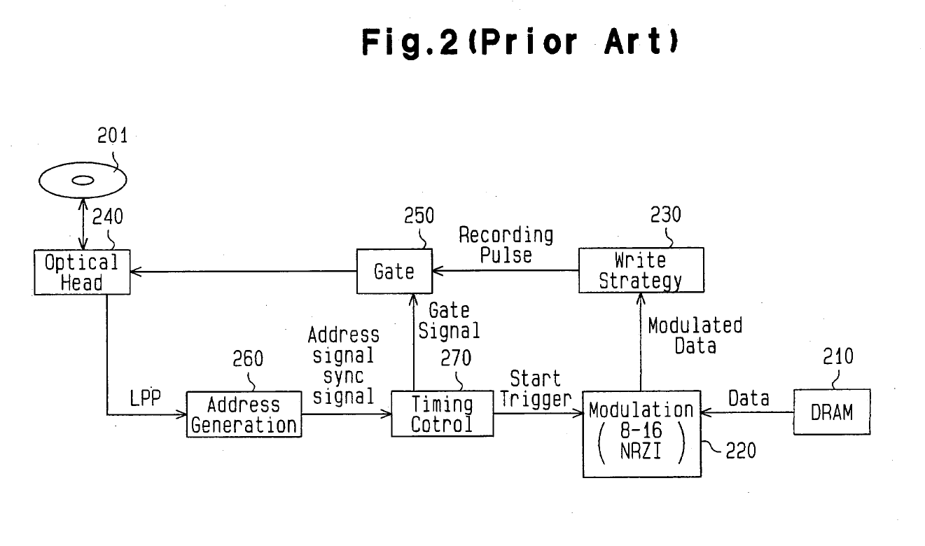

FIGS. 3A and 3B are timing charts illustrating the operation of the prior art data recording controller;

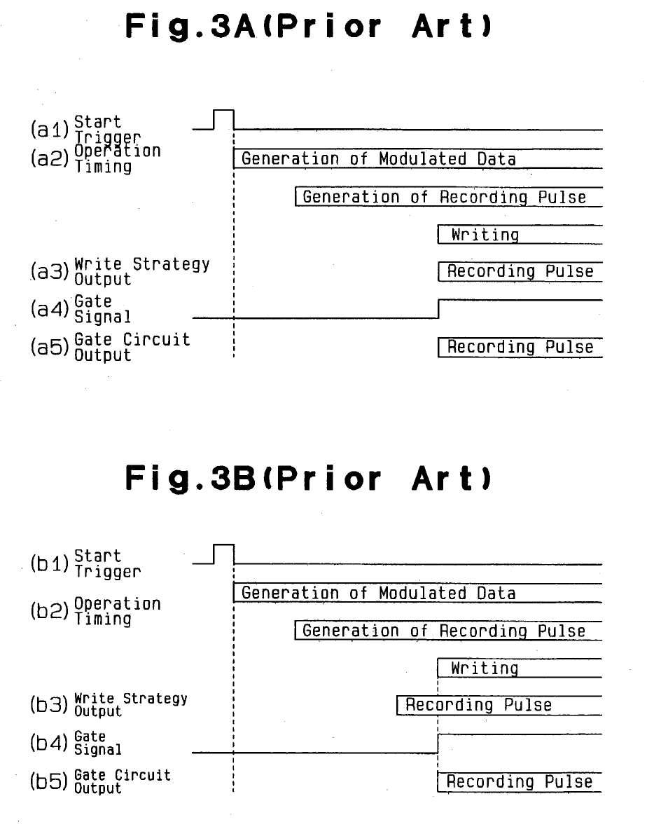

FIG. 4 is a block diagram of a data recording controller according to a preferred embodiment of the present invention;

FIG. 5 is a flowchart illustrating the procedure for recording data with a timing control circuit shown in FIG. 4; and

FIGS. 6A and 6B are timing charts illustrating the operation of the data recording controller.

### DETAILED DESCRIPTION OF THE PREFERRED EMBODIMENTS

A data recording controller 100 according to a preferred embodiment of the present invention will now be discussed.

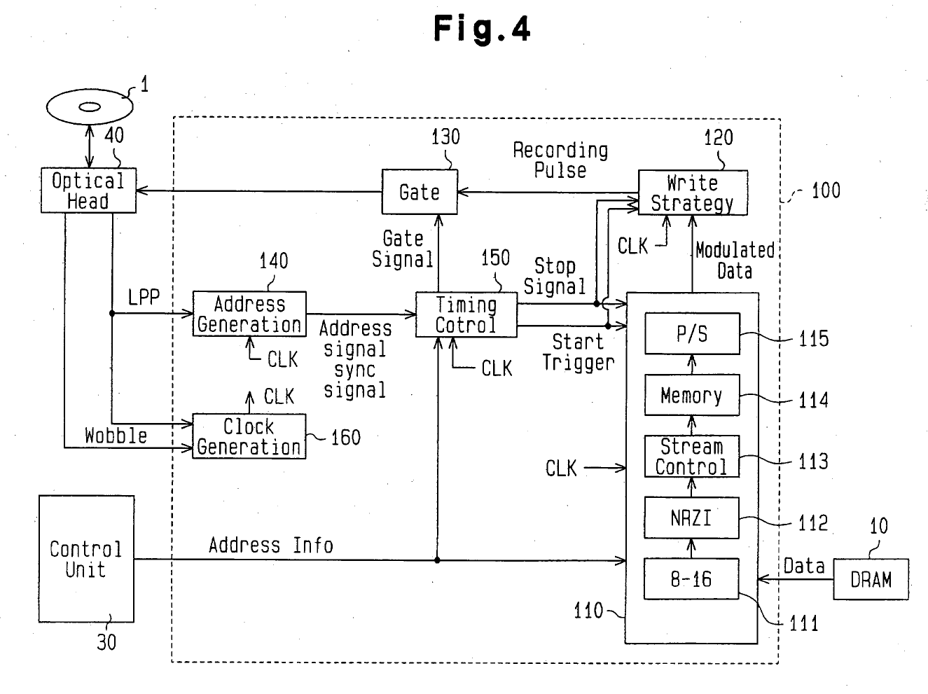

With reference to FIG. 4, an optical disk 1 is, for example, a DVD. The data recording controller 100 retrieves the data stored in the DRAM 10, generates a recording pulse signal in accordance with the data, and provides the recording pulse signal to an optical head 40. A control unit 30, which is incorporated in a data recorder together with the data recording controller, includes a microcomputer for controlling at least the data recording controller 100. The control unit 30 provides the data recording controller 100 with address information, such as an address of the subject recording data in the DRAM 10 or an address of the optical disk 1 corresponding to a recording initiation timing.

The data recording controller 100 will now be discussed.

A modulation circuit 110 modulates data, which is coded in accordance with a DVD format, to modulated data, which is recorded on the optical disk 1. More specifically, the modulation circuit 110 modulates the data read from the DRAM 10 to modulated data by performing NRZI modulation and 8-16 modulation (EFM Plus). The modulation circuit 110 includes an 8-16 modulator 111, an NRZI converter 112, a stream controller 113, a memory 114, and a parallel/serial (P/S) converter 115.

The 8-16 modulator 111 modulates data having 8 bits to data having 16 bits. A modulation table having multiple modulation candidates (16-bit data) for each piece of 8-bit data is used during the modulation. The conversion table designates multiple 16-bit data modulation candidates, which are generated by modulating 8-bit data, and designates the next state used to modulate the next 8 bits of data. When modulating 8-bit data to 16-bit data, the 8-16 modulator selects one or more of the modulation candidates by referring to the next state added to previously modulated data.

The NRZI converter 112 generates NRZI data (pulse signal), which inverts the logic level of the modulated data provided from the 8-16 modulator 111, whenever the bit content of the modulated data becomes low (the logic level being high). In the subsequent process, pits are formed in the optical disk 1 in accordance with whether the logic level of the NRZI data is inverted.

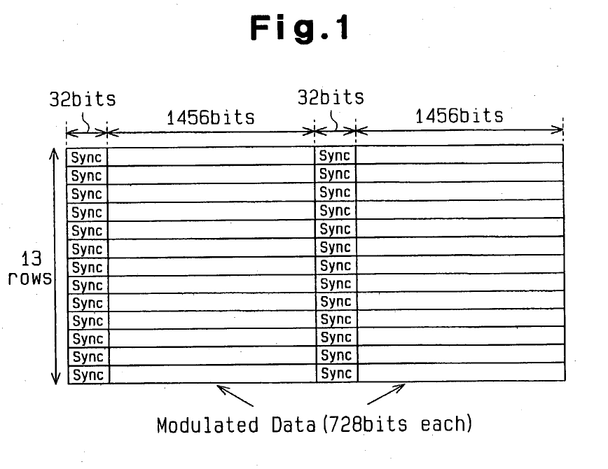

The stream controller 113 selects one modulation candidate that is used as modulated data from the multiple modulation candidates generated by the 8-16 modulator 111. That is, in accordance with the next state, certain modulation candidates are selected from multiple 16-bit candidates in the modulation table. At this point, one or more candidates are determined. For example, if two modulation candidates are determined, the stream controller 113 generates a stream of data in correspondence with the two modulation candidates and stores the data stream in the memory 114. In other words, each modulation candidate is associated one-by-one with the next modulation candidate, which is designated by the added next state, to generate a data stream connected to the two modulation candidates. Each data stream is stored in the memory 114. In the stream controller 113, whenever the data length of the data stream connected to two modulation circuits becomes equal to the data length of a single frame, which is shown in FIG. 1, a certain single data stream is determined as the modulated data. The certain data stream is determined in accordance with a DC component evaluation (digital sum variation, i.e., DSV) of the data stream connected to each modulation candidate.

The final modulated date is determined in this manner by determining a certain data stream. The P/S converter 115 converts the determined modulated date to serial data. Accordingly, the modulated date output from the modulation circuit 110 is serial data.

The write strategy circuit 120 receives the modulated data, performs a predetermined pulse conversion process on the modulated data to generate the recording pulse signal, which controls the intensity (power) and radiation time of the laser beam, and provides the recording pulse signal to the gate circuit 130. A write strategy circuit described in, for example, Japanese Laid-Open Patent Publication No. 6-313329 or Japanese Laid-Open Patent Publication No. 2000-57571, may be used as the write strategy circuit 120.

In response to a gate signal, the gate circuit 130 connects the write strategy circuit 120 to a circuit located outside the data recording controller 100, such as the optical head 40. This provides the recording pulse signal to the optical head 40 from the write strategy circuit 120. The optical head 40 generates a laser beam in accordance with the recording pulse signal and radiates the laser beam to the data recording controller 100.

The data recording controller 100 calculates (locates) the position of a laser beam spot (radiation position) on the optical disk 1 from the LPP signal. More specifically, the address generation circuit 140 generates the LPP signal to generate the synchronization signal, which corresponds to the sync section (FIG. 1) of the channel data, and the address signal, which corresponds to the position information of the optical disk 201. The address signal and the synchronization signal are used to locate the laser beam spot position.

The timing control circuit 150 adjusts the generation and output timing of the recording pulse signal in accordance with the calculated laser beam spot position.

The modulation circuit 110, the write strategy circuit 120, the address generation circuit 140, and the timing control circuit 150 are operated in accordance with a clock signal CLK generated by the clock generation circuit 160. The clock generation circuit 160 generates the clock signal CLK from the LPP signal and the wobble signal, which are output from the optical head 40. The clock generation circuit 160 includes a PLL circuit. When retrieving the wobble signal and generating the clock signal at a predetermined frequency, the PLL circuit further retrieves the LPP signal to finely adjust the frequency and generate the clock signal CLK. The PLL circuit may be one that is described in, for example, the publication of Japanese Patent Application No. 2000-0128159, the publication of Japanese Patent Application No. 2000-038193, and the publication of Japanese Patent Application No. 2000-049702. Further, a circuit that generates the clock signal CLK from either the wobble signal or the LPP signal may be used as the clock signal CLK.

The modulation circuit 110, the write strategy circuit 120, the address generation circuit 140, and the timing control circuit 150 operate in accordance with the clock signal CLK. Thus, the operations of these circuits correspond to the rotation of the optical disk 1.

The control performed by the data recording controller 100 in relation with the initiation of data recording will now be discussed.

When the control unit 30 issues a command to record predetermined data, which is stored in the DRAM 10, the timing control circuit 150 of the data recording controller 100 issues the following commands. One command is a first start trigger signal (modulation initiation command) provided to the modulation circuit 110. The first start trigger signal starts modulation at a timing that is earlier than the timing at which the laser beam spot reaches the data recording initiation position by the total of the time required for modulating data having a predetermined number of bytes, the time required for generating the recording pulse signal, and a predetermined margin time. A further command is a stop signal (wait command) provided to the write strategy circuit 120 so that the circuit 120 waits until the laser beam spot position reaches the desired position for starting recording (recording initiation position) before outputting the recording pulse signal, which is the desired recording subject.

Due to the early modulation initiation, the laser spot position is located in front of the recording pulse signal when the recording pulse signal of the input data is prepared. Accordingly, the recording of data is accurately started when the laser beam spot reaches the recording initiation position. Thus, even if the rotation speed of the optical disk 1 changes slightly or the pickup of the optical head 40 sways sideward, the initiation of data recording is not delayed. Thus, the recording of data is accurately started.

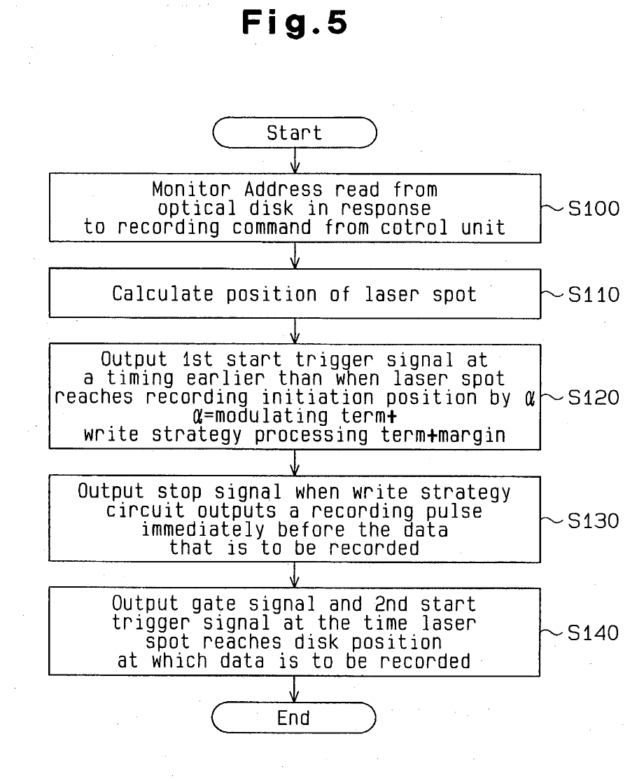

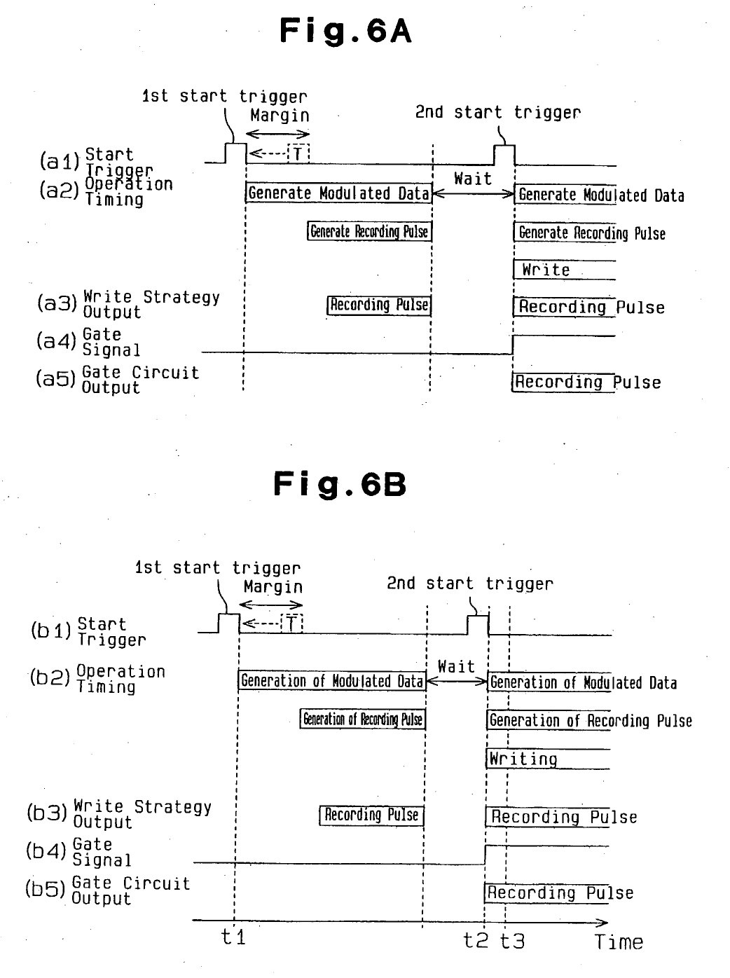

The processing performed by the timing control circuit 150 will now be discussed with reference to FIGS. 5, 6A, and 6B. In the processing illustrated in FIG. 5, recording starts from the addition of data, or from the data at the middle of a block.

In step S100, when receiving a data recording command from the control unit 30, the timing control circuit 150 starts monitoring the address signal and the synchronization signal, which are provided from the address generation circuit 140.

In step S110, the timing control circuit 150 calculates the position of the laser beam spot from the monitored address information. Based on, for example, the synchronization signal, which is provided cyclically, or the address signal, the timing control circuit 150 calculates the laser beam spot position up to bit units between synchronization signals. In other words, the data recording position on the optical disk 1 is calculated in detail in accordance with the bit units of the data.

In step S120, the timing control circuit 150 calculates the timing at which the calculated laser beam spot position reaches the data recording initiation position. Further, the timing control circuit 150 causes the first start trigger signal to go high at a timing earlier than the timing at which the data recording initiation position is reached by the total of the time required for generating modulated data, the time required for generating the recording pulse signal, and the predetermined margin time. In response to the high first start trigger signal, the modulation circuit 110 starts modulation, and the write strategy circuit 120 starts conversion.

The processing of step S120 will now be discussed in detail. The timing control circuit 150 first calculates the number of addresses in which the laser beam spot advances on the optical disk 1 during the time required for the modulation of data having a predetermined number of bytes (e.g., the number of bytes for a single word) and the time required for converting the modulated data to recording pulses. The timing control circuit 150 subtracts the calculated address from the address corresponding to the recording initiation timing, which is provided by the control unit. This obtains the address of an original modulation initiation timing. Further, the number of addresses corresponding to the predetermined margin time is subtracted from the original address to obtain a modulation initiation address. When the address read from the optical disk 1 reaches the modulation initiation address, the timing control circuit 150 causes the first start trigger signal to go high. In response to the first start trigger signal, the modulation circuit 110 starts modulation from a timing prior to the timing at which the modulation should originally have started. The control unit 30 may perform the number of addresses that are advanced during the modulation time and the generation time of the recording pulse signal. In this case, the control unit 30 subtracts the calculated address from the recording initiation address to generate the modulation initiation address and provides the original modulation initiation address to the data recording controller 100.

The modulation time and generation time of the recording pulse signal may be measured from the number of pulses in the clock signal CLK generated by the clock generation circuit 160. That is, the modulation circuit 110 and the write strategy circuit 120 operate in synchronism with the clock signal CLK. Thus, the number of pulses required for processing a predetermined number of bytes is constant. Accordingly, the time required for modulation and the time required for converting channel bits to the recording pulse signal may be measured from the pulse number of the clock signal CLK.

The margin time is set at a time that enables the write strategy circuit 120 to complete the generation of the recording pulse signal before the laser spot position reaches the recording initiation position even if the rotation speed of the optical disk 1 changes slightly or the pickup in the optical head 4 sways sideward.

As shown in FIG. 6A, the modulation circuit 110 starts modulating data in response to the first start trigger signal (a2). The modulation circuit 110 modulates data in single block units, which is the unit of a DVD error correction code (ECC). The data of a single block corresponds to 16 of the sector of modulated data shown in FIG. 1.

Then, when the write strategy circuit 120 receives the modulated data from the modulation circuit 110, as shown by (a3), the write strategy circuit 120 generates and sequentially outputs the recording pulse signal. However, at this point, as shown by (a4), the timing control circuit 150 does not provide the gate circuit 130 with the gate signal. Thus, as shown by (a5), the gate circuit 130 does not provide the optical head 40 with the recording pulse signal.

In step S130, the timing control circuit 150 provides the write strategy circuit 120 and the modulation circuit 110 with the stop signal (wait command) when the write strategy circuit 120 outputs the recording pulse corresponding to the data immediately before the data that is to be recorded. In response to the stop signal, the write strategy circuit 120 stops generating the recording pulse signal, and the modulation circuit 110 stops performing modulation.

Referring to FIG. 6A, the write strategy circuit 120 and the modulation circuit 110 hold the signals they have when receiving the stop signal. For example, the write strategy circuit 120 holds the data from the head of the data that is to be recorded to several bits. This is because the write strategy circuit 120 performs an operation with a latch circuit, such as a flip-flop when generating the recording pulse signal. The conversion of the channel data to the recording pulse signal is stopped by, for example, stopping providing the latch circuit in the write strategy circuit 120 with the clock signal CLK. Further, the data, which the latch circuit has when conversion is stopped, is held in the write strategy circuit 120.

The modulation circuit 110 has a latch circuit (not shown), such as a flip-flop to perform modulation. Accordingly, the modulation circuit also stops modulation by stopping provision of the clock signal CLK to the latch circuit in response to the stop signal or by stopping the memory 114. Further, the data in the latch circuit and the memory 114 is held when modulation is stopped.

In step S140, the timing control circuit 150 causes the gate signal and the second start trigger signal to go high when the laser beam spot position reaches the desired position on the optical disk 1. Thus, when the laser beam spot position reaches the recording initiation position, the recording pulse signal corresponding to the data that is to be recorded is provided from the gate circuit 130 to the optical head 40 to record the data at the desired position on the optical disk 1.

In the preferred embodiment, the first start trigger signal goes high at a timing earlier than the conventional timing (T) by the margin time. This ensures that data recording is started. For example, referring to FIG. 6B, the predicted output timing of the gate signal at time t1 is time t3. However, even if the output timing of the gate signal becomes earlier than the time t2, the recording of data is accurately started.

The preferred embodiment has the advantaged described below.

(1) The modulation circuit 110 is provided with an activation signal (first start trigger signal) to start the modulation of data at a timing that is earlier than the timing at which the laser beam spot reaches the data recording initiation position by the total of the predetermined margin time and the time required to modulate data and generate the recording pulse signal. Thus, the laser beam spot position is located at a position in front of the recording initiation position upon completion of the modulation performed by the modulation circuit 110 and the generation of the recording pulse signal by the write strategy circuit 120. Since there is the predetermined margin time before the laser beam spot position reaches the predetermined margin time, the recording of data is accurately started even when the rotation speed of the optical disk 1 changes slightly or when the pickup of the optical head 40 sways sideward.

(2) The write strategy circuit 120 waits until the laser beam spot position reaches the data recording initiation position before outputting the recording pulse signal of the data that is to be actually recorded. Further, the write strategy circuit 120 is provided with the second start trigger signal at a timing in which the laser beam spot reaches the recording position. Accordingly, the recording pulse signal is output from the write strategy circuit 120 at a proper timing. In addition, the recording of data is accurately started even if the rotation speed of the optical disk changes slightly or if the pickup of the optical head 40 sways sideward.

(3) Due to the gate circuit 130, the control unit 30 starts recording data from the middle of a block in a code word related with the DVD error correction. For example, the recording of data may be started from the end of the data that is already recorded on the optical disk 1.

It should be apparent to those skilled in the art that the present invention may be embodied in many other specific forms without departing from the spirit or scope of the invention. Particularly, it should be understood that the present invention may be embodied in the following forms.

The address generation circuit 140 does not necessarily have to calculate the position of the laser beam spot on the optical disk 1 from the LPP signal. For example, when recording additional data continuously from the data that is already recorded on the optical disk 1, the laser beam spot position on the optical disk 1 may be calculated based on the recorded data. This may be performed through the following procedure:

1. Before starting to record, the recorded data is traced with a reproduction laser beam to reproduce the recorded data;

2. The recorded data is demodulated; and

3. An address signal representing a laser beam spot position is generated from the address information of the demodulated data.

The data recording controller is not limited to the above configuration. For example, the address generation circuit that generates an address signal corresponding to the laser beam spot position on the optical disk 1 may be eliminated from the data recording controller, and the address signal may be retrieved from an external device.

The modulation circuit 110 does not necessarily have to modulate every block of data.

When there is a restriction applied to the head of data when restarting recording, such as in the head of the frame shown in FIG. 1, the desired data may be recorded by holding the recording pulse signal converted by the write strategy circuit and waiting even if the gate circuit 130 is eliminated.

Instead of holding the recording pulse signal in the write strategy circuit 120, the modulation circuit may wait while holding the head of the modulated data that is to be recorded until the laser beam spot is delayed from the desired position by the time required to perform the predetermined conversion in the write strategy circuit.

The present invention is not restricted to a DVD and may also be applied to other disk media including an optical disk, such as a compact disc-recordable (CD-R), or a magneto-optical disk, such as an MO or a mini disc (MD).

The present examples and embodiments are to be considered as illustrative and not restrictive, and the invention is not to be limited to the details given herein, but may be modified within the scope and equivalence of the appended claims.

What is claimed is:

1. A controller for controlling the recording of data using a recording laser beam to a disk medium from which an address signal is read, the controller comprising:
a modulation circuit for modulating data that is to be recorded to generate modulated data;
a write strategy circuit connected to the modulation circuit to generate a recording pulse signal for controlling output of the recording laser beam in accordance with the modulated data;
a timing control circuit connected to the write strategy circuit to control operation timing of the modulation circuit and the write strategy circuit in accordance with the address signal read from the disk medium, the timing control circuit temporarily stopping operation of the modulation circuit and the write strategy circuit and starting operation of the modulation circuit and the write strategy circuit when the position of a spot of the recording laser beam on the disk medium reaches a recording initiation position.

2. The controller according to claim 1, wherein the timing control circuit starts modulation with the modulation circuit when the data that is to be recorded is provided and stops operating the modulation circuit and the write strategy circuit when the modulation of data at the head of the data that is to be recorded is completed.

3. The controller according to claim 1, wherein the timing control circuit starts operation of the modulation circuit at a timing earlier than the timing at which the recording laser beam spot reaches the recording initiation position by the total of the modulation time required by the modulation circuit, the generation time of the recording pulse signal required by the write strategy circuit, and a predetermined margin time.

4. The controller according to claim 3, further comprising a gate circuit connected between the write strategy circuit and an optical head for generating the recording laser beam, wherein the gate circuit is switched on in response to a gate signal, and when the position of the laser beam spot reaches the recording initiation position, the timing control circuit generates a start trigger signal, which activates the modulation circuit and the write strategy circuit, and provides the gate circuit with the gate signal.

5. A controller for controlling the recording of additional data using a recording laser beam to a disk medium from the end of data that has already been recorded on the disk medium, the controller comprising:
a modulation circuit for modulating the additional data to generate modulated data;
a write strategy circuit connected to the modulation circuit to generate a recording pulse signal for controlling output of the recording laser beam in accordance with the modulated data;
a gate circuit connected to the write strategy circuit to send the recording pulse signal to the external circuit; and
a timing control circuit for controlling the operation timing of the modulation circuit, the write strategy circuit, and the gate circuit, the timing control circuit:
generating a recording pulse signal corresponding to the additional data by operating the modulation circuit and the write strategy circuit during a predetermined period while stopping the operation of the gate circuit;
temporarily stopping the modulation circuit and the write strategy circuit immediately before the write strategy circuit outputs the recording pulse signal corresponding to the additional data; and
starting the operation of the modulation circuit, the write strategy circuit, and the gate circuit at a timing in which a spot of the recording laser beam on the disk medium reaches a recording initiation position.

6. The controller according to claim 5, wherein the timing control circuit starts operation of the modulation circuit at a timing earlier than the timing at which the recording laser beam spot reaches the recording initiation position by the total of the time required for modulation, the time required for generation of the recording pulse signal, and a predetermined margin time.

7. A controller for controlling the recording of data using a recording laser beam to a disk medium, the controller comprising:
a modulation circuit for modulating data that is to be recorded to generate modulated data;
a write strategy circuit connected to the modulation circuit to generate a recording pulse signal for controlling output of the recording laser beam in accordance with the modulated data;
a gate circuit connected to the write strategy circuit to output a recording pulse signal; and
a timing control circuit for controlling the operation timing of the modulation circuit, the write strategy circuit, and the gate circuit, the timing control circuit calculating the timing at which the recording laser beam spot reaches a recording initiation position on the disk medium and activating the modulation circuit at a timing that is earlier than the calculated timing by the total of the time required for modulating a predetermined number of bits of the data that is to be recorded, the time required for generation of the recording pulse signal from the modulated data, and a predetermined margin time.

8. The controller according to claim 7, wherein the timing control circuit temporarily inactivates the modulation circuit and the write strategy circuit immediately after the write strategy circuit outputs the recording pulse signal in correspondence with the data immediately prior to the data that is to be recorded.

9. The controller according to claim 8, wherein the timing control circuit activates the modulation circuit and the write strategy circuit and switches on the gate circuit at a timing in which the recording laser beam spot reaches the recording initiation position.

10. A controller for controlling the recording of data using a recording laser beam to a disk medium, the controller comprising:
a modulation circuit activated in response to a start trigger signal and inactivated in response to a stop signal, wherein the modulation circuit modulates input data to generate modulated data;
a write strategy circuit activated in response to the start trigger signal and inactivated in response to the stop signal, wherein the write strategy circuit generates a recording pulse signal for controlling output of a recording laser beam in accordance with the modulated data;
a gate circuit connected to the write strategy circuit to send the recording pulse signal to an external circuit in response to a gate signal; and
a timing control circuit for generating the start trigger signal, the stop signal, and the gate signal, the timing control circuit:
calculating the timing at which the recording laser beam spot reaches a recording initiation position on the disk medium to provide the modulation circuit and the write strategy circuit with the start trigger signal at a timing that is earlier than the calculated timing by the total of the time required for generating the recording pulse signal from a predetermined number of bits of the data that is to be recorded and a predetermined margin time;
providing the modulation circuit and the write strategy circuit with the stop signal immediately before the write strategy circuit outputs the recording pulse signal; and
providing the modulation circuit and the write strategy circuit with the start trigger signal and providing the gate circuit with the gate signal at a timing in which the recording laser beam spot reaches the recording initiation position.

11. A method for controlling the recording of data using a recording laser beam to a disk medium, the method comprising:
calculating a timing in which a spot of the recording laser beam reaches a recording initiation position on the disk medium;
starting generation of modulated data at a timing earlier than the calculated timing by a total of the time required for generating a recording pulse signal, which controls the recording laser beam, from data that is to be recorded and a predetermined margin time;
temporarily stopping the generation of the modulated data and the generation of the recording pulse signal when the recording pulse signal corresponding to the data immediately before the data that is to be recorded is output; and
restarting the generation of the modulated data and the generation of the recording pulse signal at a timing at which the laser beam spot reaches the recording initiation position.
